(19) United States
(12) Patent Application Publication
(10) Pub. No.: US 2007/0236174 A1
(43) Pub. Date: Oct. 11, 2007

(54) Point-Of-Sale Non-Contact Charging

(76) Inventor: Evan John Kaye, Short Hills, NJ (US)

Correspondence Address: EVAN J. KAYE, 54 FOREST DRIVE, SHORT HILLS, NJ, 07078, US

(21) Appl. No.: 11/733,170

(22) Filed: Apr. 9, 2007

Related U.S. Application Data
(60) Provisional application No. 60/744,506, filed on Apr. 9, 2006.

(51) Int. Cl. H02J 7/00

(52) U.S. Cl. 320/112; 320/107

(57) ABSTRACT

A point-of-sale non-contact charging system to charge portable electronic devices through their packaging on store shelves makes use of electromagnetic induction so that the integrity of the packaging can be maintained and the products can be freely positioned on store shelves. Since the current can be induced in a conductive coil outside of the portable electronic device, the device need not be modified to be charged through this mechanism.

### RELATED U.S. APPLICATION DATA

This is the non-provisional application of provisional application No. 60744506, filed on Apr. 9, 2006.

### FIELD OF THE INVENTION

The present invention relates to inductively charging rechargeable battery packs of portable electronic devices while they are stored in retail packaging.

### BACKGROUND OF THE INVENTION

Many consumer electronic devices nowadays contain rechargeable battery packs. Oftentimes the problem for the consumer is that when they first purchase the device, the battery pack is not fully charged and it requires a good number of hours charging before the device can be used. The problem for retail stores, particularly at airports and other centers where impulse purchasing is more likely is that customers are less likely to purchase the products knowing that they will not be able to use them right away. A fully charged device would be ideal but it would currently require stores to open the packaging of the devices and charge them individually.

Inductive coupling for non-contact charging is becoming increasingly popular for charging the battery packs of certain electronic devices (e.g. in electric toothbrushes). The mechanism involved is a primary coil linked to an oscillating power source that creates a magnetic field. A secondary coil in close proximity with the primary coil, and within the magnetic field, has a current induced in it.

While most electronic devices with rechargeable battery packs have a port through which a current is delivered to charge the battery pack, some newer devices have been disclosed where there is a coil within the device, or its battery pack that can absorb the energy of an external changing magnetic field in the form of an electric current. Therefore charging occurs when that device is placed on a charging mat that contains primary coils with oscillating current flowing through them generating a changing magnetic field above the mat. However, even these newer devices still have the problem of having uncharged battery packs at the time of purchase in a retail setting.

Thus, what is needed in the art and has not yet been described is an in-store on-shelf in-packaging charging mechanism to charge both traditional rechargeable battery pack devices, and newer non-contact charging devices.

### SUMMARY OF THE INVENTION

Aspects of the present invention relate to inductively charging the battery packs of packaged portable electronic devices. An inductive charging arrangement usually comprises at least two coils. A primary coil contains an oscillating current, and is embedded in a matt placed or stuck on the shelf It may also be embedded within the shelf, and there may be a plurality of primary coils. A secondary coil has a current induced in it via the changing magnetic field and it resides either within the packaging of the electronic device, within the battery pack of the electronic device, or within the electronic device itself.

For the energy to be efficiently transferred from the primary coil to the secondary coil, they should be in close proximity to one another. The secondary coil can be placed at the bottom of the packaging material (either on the inside or outside of the enclosure, and thereby be in close proximity to the charging shelf surface. Conductive wires connect the coil to the electronic device (or its battery pack) via the device's charging port. If the device does not have the necessary electronic components to control and convert the raw incoming current, then there can be a charging control unit between the coil and the device.

For devices that have battery packs containing charging coils, the battery pack can be placed at the bottom of the packaging material, but still within the packaging, while the actual electronic device could be more to the center of the packaging for maximum padding protection.

So that store workers know that devices are being charged there can also be a LED indicator, or similar, within the packaging and powered by the current in the coil to show that charging is taking place. Similarly, so that customers know a device is charged, there can be a similar indicator, powered either by the battery pack or the charging control unit that shows when a device is fully charged.

### BRIEF DESCRIPTION OF THE FIGURES

FIG. 1 is a schematic representation of a shelf charging system with one layer of products for electronics products that are charged through a charging port;

FIG. 2 is a schematic representation of the wiring within the packaging;

FIG. 3 is a schematic representation of a shelf charging system, with multiple layers of products;

FIG. 4 is a schematic representation of the wiring within the packaging to enable charging of multiple layers of products;

FIG. 5 is a schematic representation of the packaging wherein a non-contact charging battery pack is positioned in proximity to the shelf but still attached to the device;

FIG. 6 is a schematic representation of the packaging wherein a non-contact charging battery pack is positioned in proximity to the shelf separate from the device;

FIG. 7a, 7b, 7c respectively illustrate variations on the position of the shelf coil

### DETAILED DESCRIPTION OF THE PREFERRED EMBODIMENT

The present invention and its embodiments are best described by way of description of the accompanied figures.

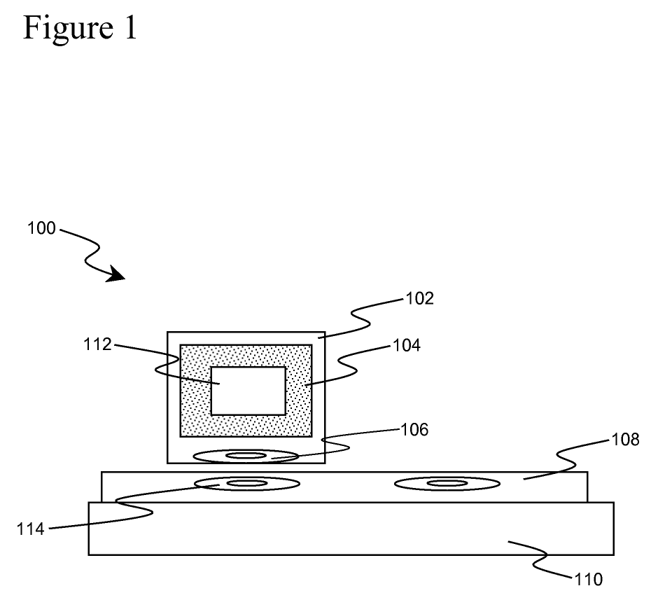

FIG. 1 is a schematic representation 100 of a shelf charging system that has a single layer of packaged rechargeable electronic devices resting on it. The electronic device 112 is surrounded by protective packaging 104, often polystyrene foam or similar, which is in turn surrounded by the external packaging 102, often cardboard printed packaging with or without windows allowing visualization of the electronic device 112. Within the external packaging 102 there is also represented a secondary coil 106 in which a current can be induced by magnetic means. The secondary coil 106 is on the periphery of the contents of the external packaging 106. The secondary coil 106 could also be on the outside of the external packaging 106, and there could also be multiple secondary coils. The electronic device 112, with its protective packaging 104 and external packaging 106 is illustrated as residing on a shelf 110, as commonly displayed in stores. Between the shelf 110 and the external packaging 106 is an enclosure 108 that houses one or more primary coils 1 14. The primary coils 114 are used to create a dynamic magnetic field that induces a current in the secondary coil 106 as well known by those skilled in the art of electromagnetic induction.

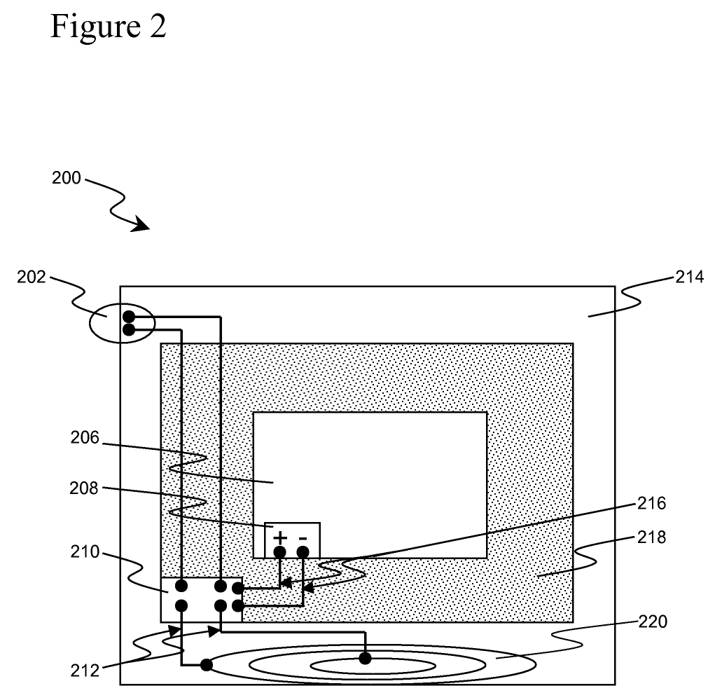

With reference now to FIG. 2, a schematic representation 200 of exemplary wiring within the external packaging for a rechargeable electronic device is presented. An electronic device 206 with a charging port 208 is surrounded by protective packaging 218 which is in turn surrounded by external packaging 214. Within the external packaging 214 there is a secondary coil 220 in which a current can be induced by magnetic means. The secondary coil 220 is on the periphery of the contents of the external packaging 214. Within the external packaging 214 there is also a charging controller 210 which is responsible for converting the raw oscillating current induced in the secondary coil 220 to a current that is suitable for charging the electronic device 206 via the charging port 208. The charging controller 210 is also responsible for protecting the electronic device 206 should a large current develop in the secondary coil 214. The raw current is transferred from the secondary coil 214 to the charging controller 208 via a coil-controller conduit 212. The processed current, often direct current (DC), is delivered from the charging controller 208 to the electronic device 206 via a controller-device conduit 216. A light emitting diode (LED) indicator 202 powered by the charging controller 208 via a controller-LED conduit 204, is lit up either when the charging controller 208 detects that the electronic device 206 is fully charged, or whenever there is a current present in the secondary coil 214. Such an indicator is useful for the purchaser of the product, as it serves to reassure the purchaser that the product is fully charged, or in the process of being charged. While the LED is the preferred embodiment, the indicator may also be a liquid crystal display (LCD), or other visible electronic indicator. In the case of the LCD, a status of the degree to which the battery is charged, or rate of charging, may be displayed.

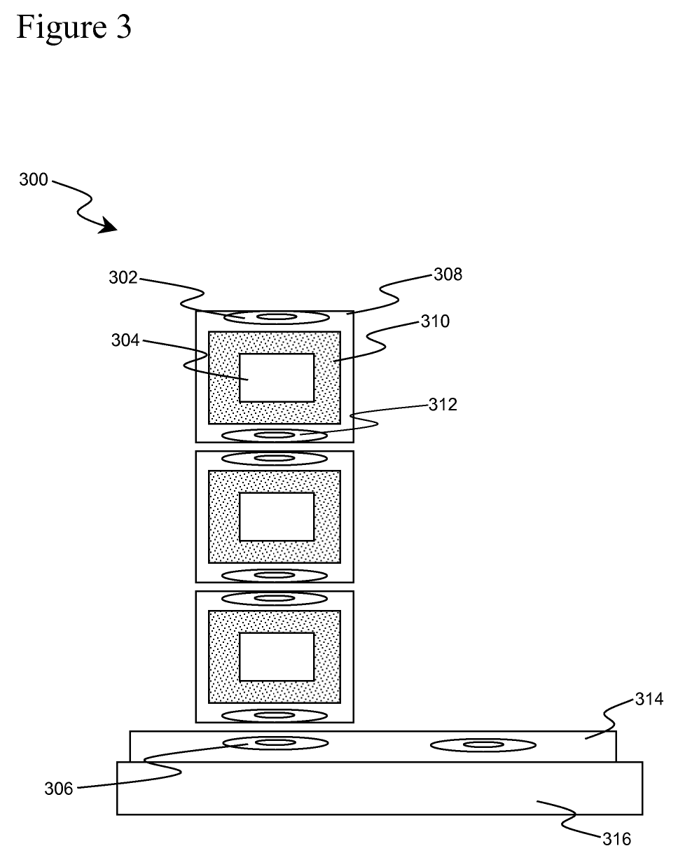

With reference now to FIG. 3, a schematic representation 300 of a shelf charging system that has three layers of packaged rechargeable electronic devices resting on it. The electronic device 304 is surrounded by protective packaging 310, which is in turn surrounded by the external packaging 308. Within the external packaging 308 there is also represented a secondary coil 312 in which a current can be induced by magnetic means. The secondary coil 312 is on the bottom of the contents of the external packaging 308. There is also a top coil 302 which is powered by the secondary coil 312. The top coil 302 creates a dynamic magnetic field when a changing electric current is passed through it. In this way it acts to induce a current in a nearby coil. Therefore the top coil 302 will act to induce a current in any coil within a package that is placed in proximity of the top coil 302 when a changing electric current is passing through the top coil 302. The secondary coil 312 and top coil 302 are connected to each other, either directly, or through a charging controller 210 (see FIG. 2) such that the raw changing electric current induced in the secondary coil 312 is transferred to the top coil 302, and in turn this top coil 302 will generate a changing magnetic field to induce an electric current in a similarly packaged item that is placed on top of it. The initial energy is provided by one or more primary coils 306 that is housed in an enclosure 314 and rests on a shelf 316.

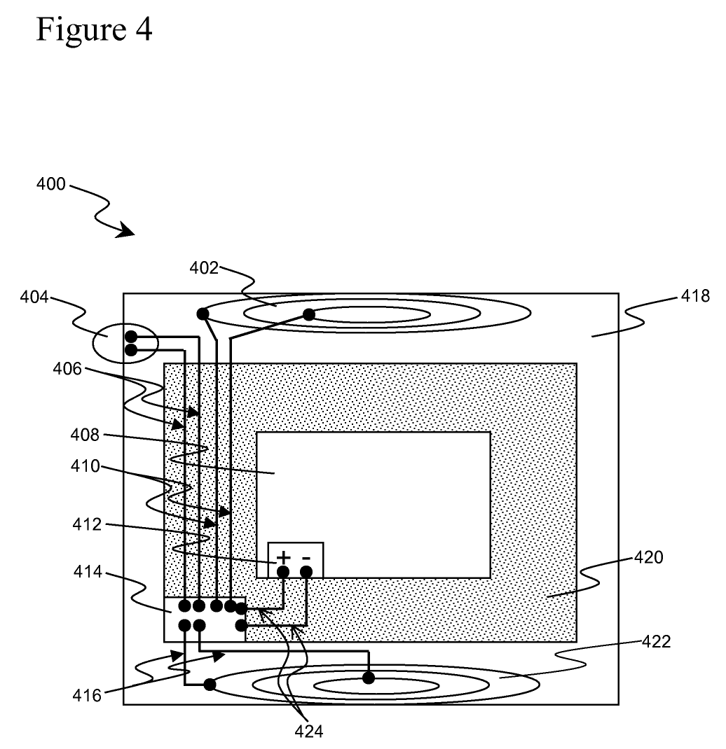

With reference now to FIG. 4, a schematic representation 400 of exemplary wiring within the external packaging for a rechargeable electronic device is presented. An electronic device 408 with a charging port 412 is surrounded by protective packaging 420 which is in turn surrounded by external packaging 418. Within the external packaging 418 there is a secondary coil 422 in which a current can be induced by magnetic means. The secondary coil 422 is on the periphery of the contents of the external packaging 418. Within the external packaging 418 there is also a charging controller 414 which is responsible for converting the raw oscillating current induced in the secondary coil 422 to a current that is suitable for charging the electronic device 408 via the charging port 412. The charging controller 414 is also responsible for protecting the electronic device 408 should a large current develop in the secondary coil 422. The raw current is transferred from the secondary coil 422 to the charging controller 414 via a coil-controller conduit 416. The processed current, often direct current (DC), is delivered from the charging controller 414 to the electronic device 408 via a controller-device conduit 424. A LED indicator 404 powered by the charging controller 414 via a controller-LED conduit 406, is lit up either when the charging controller 414 detects that the electronic device 408 is fully charged, or whenever there is a current present in the secondary coil 422. Such an indicator is useful for the purchaser of the product, as it serves to reassure the purchaser that the product is fully charged, or in the process of being charged. There is also a top coil 402 which is powered by the secondary coil 422. The top coil 402 creates a dynamic magnetic field when a changing electric current is passed through it. In this way it acts to induce a current in a nearby coil. Therefore the top coil 402 will act to induce a current in any coil within a package that is placed in proximity of the top coil 402 when a changing electric current is passing through the top coil 402. The secondary coil 422 and top coil 402 are connected to each other through the charging controller 414 (see FIG. 2) such that the raw changing electric current induced in the secondary coil 422 is transferred to the top coil 402, and in turn the top coil 402 will generate a changing magnetic field to induce an electric current in the coil of similar packaging is placed on top of it.

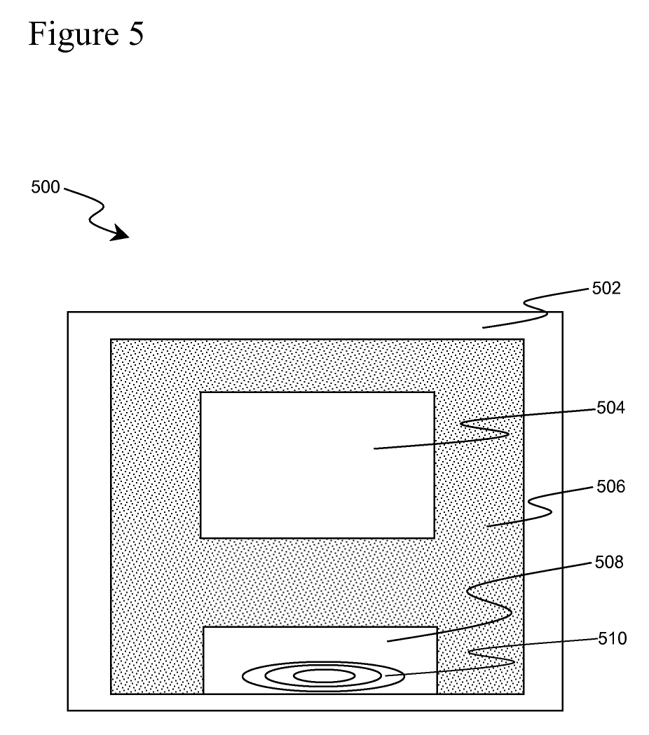

FIG. 5 is a schematic representation 500 of a packaging housing an electronic device 504. The packaging comprises a protective packaging 506 and exterior packaging 502. The electronic device 504 is positioned in the center of the protective packaging 506 to take advantage of the padding to physical damage, while the rechargeable battery pack 508 is located on the periphery of the protective packaging 506 but within the exterior packaging 502. A secondary coil 510 is housed within the rechargeable battery pack 508 and is in an optimal position to absorb the energy from a changing exterior magnetic field to create a current within the secondary coil 510 that is used to charge the rechargeable battery pack 508.

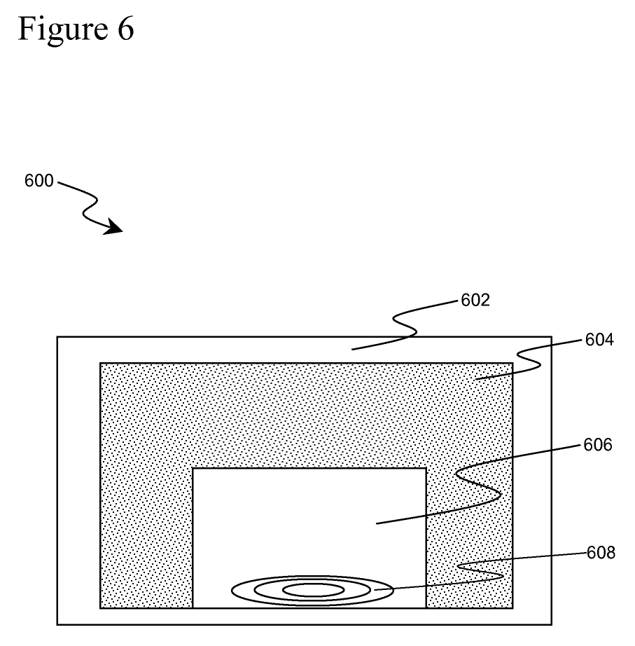

FIG. 6 is a schematic representation 600 of a packaging housing an electronic device 606. The packaging comprises a protective packaging 604 and exterior packaging 602. The electronic device 606 is positioned toward the periphery of protective packaging 604 but within exterior packaging 602. A secondary coil 608 is housed within the electronic device 606, or its attached battery pack, and is in an optimal position to absorb the energy from a changing exterior magnetic field to create a current within the secondary coil 608 that is used to charge the rechargeable batteries in the electronic device 606.

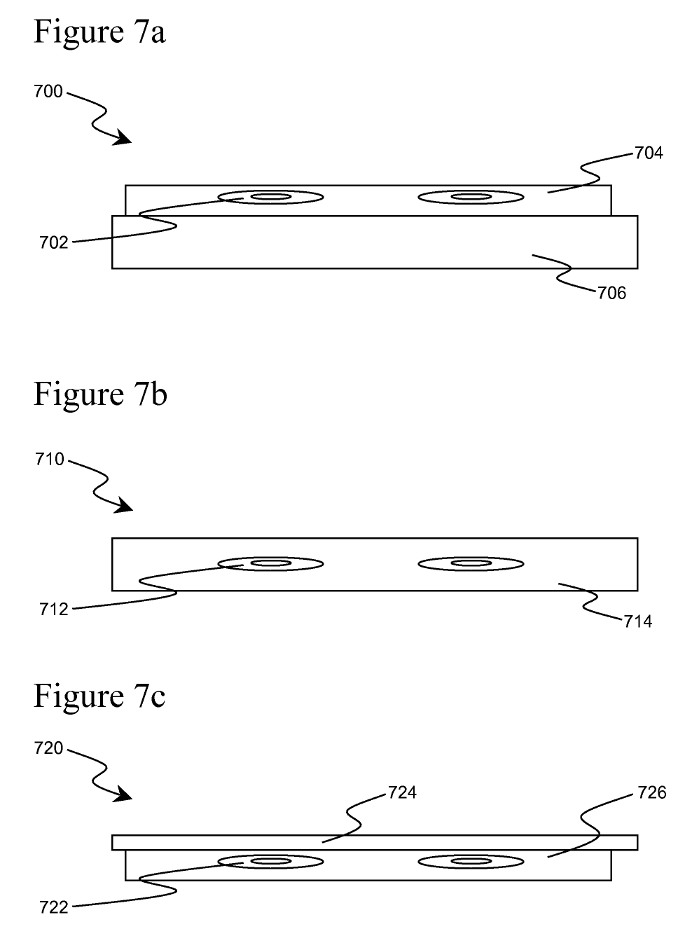

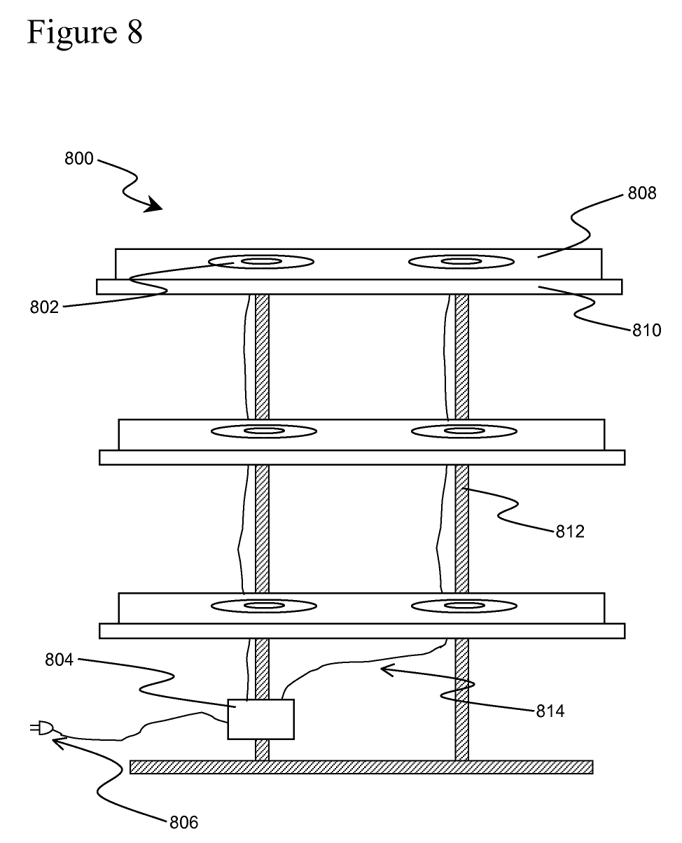

With reference now to FIGS. 7a, 7b, and 7c, three schematic representations 700, 710, 720 are presented that illustrate different ways a primary coil 702, 712, 722 can be positioned in relation to a shelf 706, 714, 724. FIG. 7a shows a schematic representation 700 of a shelf 706 that has above it an enclosure 704 containing at least one primary coil 702. FIG. 7b shows a schematic representation 710 of a shelf 714 that has within it at least one primary coil 712. FIG. 7c shows a schematic representation 720 of a shelf 724 that has below it an enclosure 726 containing at least one primary coil 722. With the configuration of FIG. 7c, the shelf 724 should be sufficiently thin or non-shielding so that the changing magnetic field is not too attenuated to significantly impact the items placed on the shelf 724. In an alternate embodiment, the primary coil 722 can be used to induce a current in the secondary coils residing in the packaging for items below it that have been stacked up from a shelf below.

FIG. 8 is a schematic representation of a standalone shelving system 800 capable of producing a changing magnetic field. A stand 812 holds at least one shelf 810 that has above it an enclosure 808 containing at least one primary coil 802. A transforming circuit 804 transforms electricity from an alternate current (AC) source 806 to a current that is appropriate and optimized for inducing electric current a secondary coil 106 (see FIG. 1). The transformed current is transferred via conduit 814 to at least one primary coil 802 within at least one enclosure 808.

Another embodiment is a docking station that transfers power to a device's battery packs to charge it. The docking station may contain a coil to receive energy and transfer it through traditional conductive means to a device while on the shelf (but still within the packaging). Similarly, the packaging itself with its coil could be used for charging the device by the user if the user has a charging mat. The packaging with a coil is similar to the docking station in this case, as both have a coil to receive the energy and delivers it to the device through conductive means.

While this invention has been described with respect to charging rechargeable battery packs, the methodology can also be used to power devices that do not contain rechargeable battery packs. For example, packaging that contains light emitting diodes (LED's) to serve an in-store on-shelf promotional purpose, but that do not need to be powered by a rechargeable battery pack can be powered by these non-contact means.

The preferred embodiment is a shelf, but this invention also encompasses other orientations, for example, an in-store hanging display where multiple packaged rechargeable electronic devices hang in line on a single rod. In a similar manner to that described in the preferred embodiment, a primary coil at the back of the line of hanging goods can power secondary coils within the adjacent packaging. The top coil 402 (see FIG. 4) would similarly be a “front coil” instead of the top orientation, and thereby power the secondary coil in front of it. Similarly, other orientations are also envisioned, which may include obscure orientations within for instance, a vending machine.

Similar shelving can also be used in a domestic environment to charge toys or other electronic devices that are fitted with appropriate secondary coils and internal electronics as described above and known to those with skill in the art.

I claim:

1. Product packaging for an electronic product, comprising:
a protective outer container;
a receiving mechanism in which an external changing magnetic field can easily produce an electric current; and
an electrically conductive conduit connecting said receiving mechanism to the enclosed product.

2. Product packaging as in claim 1, wherein said receiving mechanism is a coiled electrical conduit.

3. Product packaging as in claim 1, wherein said receiving mechanism is a printed circuit board.

4. Product packaging as in claim 1, further comprising a control circuit that converts said electric current into a processed current that is optimal for the enclosed electronic device.

5. Product packaging as in claim 1, further comprising an electrically powered indicator which is visible from outside the product packaging.

6. Product packaging as in claim 1, wherein said electrically powered indicator is a light emitting diode.

7. Product packaging as in claim 1, wherein said electrically powered indicator is a liquid crystal display (LCD).

8. Product packaging as in claim 1, further comprising an electromagnetic induction transmitting mechanism for energizing receiving conduits in close proximity.

9. Product packaging as in claim 8, wherein said transmitting mechanism is a coiled electrical conduit.

10. A shelf system for the non-contact charging of devices placed thereon, comprising:
at least one shelf;
a transforming circuit that transforms a current from a power source to a processed current that is appropriate and optimized for inducing an electric current in the receiving mechanism of enabled electronic packaging or an enabled electronic device; and
at least one transmitting mechanism that generates a changing magnetic field around it when said processed current is passed through it.

11. A shelf system as in claim 10, wherein the transmitting mechanism is an electrically conductive coil.

12. A shelf system as in claim 11, wherein said electrically conductive coil is within a printed circuit board.

13. A shelf system as in claim 11, wherein said electrically conductive coil is printed on the shelf.

14. A shelf system as in claim 10, wherein said receiving mechanism is an electrically conductive coil.

15. A shelf system as in claim 10, wherein said transmitting mechanism is embedded within said shelf.

16. A shelf system as in claim 10, wherein said transmitting mechanism is in an enclosure resting on said shelf.

18. A shelf system as in claim 11, wherein said transmitting mechanism is in an enclosure affixed to the bottom of said shelf.

19. A system for the non-contact charging of packaged portable electronic devices at the point-of-sale, comprising:
a shelf system for the non-contact charging of devices placed thereon capable of generating a changing magnetic field; and
rechargeable electronic devices packaged and connected to receiving mechanisms that can charge their battery packs when exposed to the appropriate changing magnetic field.

20. A system as in claim 19, wherein said receiving mechanisms are electrically conductive coils.

21. Packaging optimized for on-shelf non-contact charging of an enclosed portable electronic device, containing an inner protective packaging and external packaging, wherein the electronic device with its battery pack is positioned on the periphery of the protective packaging in a position where it can be optimally exposed to changing magnetic fields.
